(19) United States
(12) Patent Application Publication
(10) Pub. No.: US 2024/0043189 A1
(43) Pub. Date: Feb. 8, 2024

(54) CONTROLLED MOISTURE TRANSPORT PACKAGING FOR FRESH PRODUCE

(71) Applicant: Windham Packaging, LLC, Windham, NH (US)

(72) Inventor: Elizabeth Varriano-Marston, Windham, NH (US)

(73) Assignee: Windham Packaging, LLC, Windham, NH (US)

(21) Appl. No.: 18/117,807

(22) Filed: Mar. 6, 2023

Related U.S. Application Data
(60) Provisional application No. 63/394,688, filed on Aug. 3, 2022.

(51) Int. Cl. B65D 65/40; B65D 81/26; B32B 27/36; B32B 27/34; B32B 27/08; B32B 27/10; B32B 3/26; B32B 37/18; B32B 38/00; B32B 7/12; B32B 37/12

(52) U.S. Cl. CPC B65D 65/40; B65D 81/26; B32B 27/36; B32B 27/34; B32B 27/08; B32B 27/10; B32B 3/266; B32B 37/182; B32B 38/0004; B32B 7/12; B32B 37/1284; B65D 2565/387; B65D 2565/388; B32B 2307/7246; B32B 2439/70; B32B 2307/31; B32B 2310/0843

(57) ABSTRACT

A fresh produce package includes a laminated polymer film having water transport windows that impart a limited, controlled water vapor transport rate (MVTR), thereby avoiding produce desiccation, while also avoiding excess moisture pooling. The film comprises a low MVTR layer, such as heat-sealable PET, laminated to a high MVTR layer, such as nylon, PLA, or cellulose. The film includes lamination gaps, for example created using an adhesive spray-blocking mask or an adhesive-applying roller with insets. A cutting device, such as a laser or die-cutter, forms moisture transport windows (MTWs) by cutting out panels of the low MVTR layer in the gaps while leaving the high MVTR layer in place. Container seams can be formed by heat sealing of the low MVTR layer to itself, or to an underlying tray. The film can be gas-impermeable, and can include microperforations to establish a modified gas atmosphere within the package.

### RELATED APPLICATIONS

This application claims the benefit of U.S. Provisional Application No. 63/394,688, filed Aug. 3, 2022, which is herein incorporated by reference in its entirety for all purposes.

### FIELD OF THE INVENTION

The invention relates to packaging, and more particularly, to packaging of fresh produce.

### BACKGROUND OF THE INVENTION

Package designs for fresh produce face many challenges, because they must enable produce to remain alive and fresh within the package for as long as possible. In most cases, packaging that is tightly gas-sealed will suffocate the produce, and lead to its early demise and spoilage. For some types of produce that are whole or have a protective skin that retains moisture, such as apples and oranges, a “ventilated” packaging, may be the preferred option, whereby the atmosphere surrounding the produce is maintained close to ambient conditions, both in terms of O₂ content and humidity.

With reference to FIG. 1A, for fresh produce 102 that has a high respiration rate and a relatively low release of water vapor during storage, such as bananas and broccoli, improved freshness retention can be provided by establishing a “modified atmosphere” within the package 100. One approach to “modified atmosphere packaging” (MAP) is to provide microperforations 104 through an otherwise gas-sealed package 100, thereby permitting only a limited O₂ and CO₂ exchange rate between the interior of the package 100 and the environment. Under these conditions, the respiration of the produce results in a modified atmosphere within the package having a reduced O₂ concentration and increased CO₂ concentration as compared to ambient. This modified atmosphere slows the respiration rate of the produce 102 without causing rapid quality deterioration, thereby keeping it fresh longer than would be the case for ventilated packaging.

However, many packaging materials used for MAP packaging are substantially impermeable to moisture. With reference to FIG. 1B, for high water vapor generating produce 106 such as whole cucumbers and peppers, for example, a lack of moisture exchange with the environment can lead to pooling of excess moisture 108 within the package 100, thereby causing the produce 106 to rapidly spoil. On the other hand, too much moisture exchange, for example due to ventilated packaging, can cause the produce to dry out, i.e. become desiccated, thereby quickly reducing its freshness and consumer acceptability.

What is needed, therefore, is a fresh produce packaging solution that prevents high water vapor generating produce from being prematurely desiccated, while at the same time preventing any pooling of excess moisture within the package.

### SUMMARY OF THE INVENTION

The present invention is a is fresh produce package that prevents high water vapor generating produce from being prematurely desiccated, while at the same time preventing pooling of excess moisture within the package.

The disclosed package includes a laminate polymer film that permits a limited exchange of moisture with the environment, while preventing gas exchange with the environment. This allows high water vapor generating produce, such as cucumbers and peppers, to establish a moisture-controlled environment (MCE) within the package that avoids desiccation of the produce, while at the same time allowing a sufficient water vapor transport to avoid pooling of excess moisture within the package. In some embodiments, the disclosed “MCE” packaging is formed entirely by the laminate film, thereby providing a flexible bag or pouch. In other embodiments, the laminate film is applied as a lidding film to a rigid or semi-rigid container or tray made from a material that is impermeable to both gases and water vapor.

The laminate polymer film of the present invention includes a first film layer, such as a polyethylene terephthalate (PET) film layer, that serves as a gas and moisture barrier (very low moisture vapor transport rate, “MVTR”). The first film is laminated to a second film layer, such as a nylon, polylactic acid (PLA) or cellulose, that also provides a gas barrier, but has a much higher MVTR than the PET layer. The high MVTR of the second film layer arises from a molecular attraction between the polymer and water molecules, which draws excess moisture into the polymer, and upon saturation thereof allows some of the moisture to escape into the ambient environment. Gases such as O₂ and CO₂ have low transmission rates through the second film layer, because they do not experience a similar molecular attraction to the polymer.

In embodiments, the first film layer has an MVTR (also referred to in the art as a “water” vapor transport rate, or “WVTR”) that is no greater than 2 g-mil/100 in²-day @ 100° F. and 90% relative humidity, while the second film layer has an MVTR that is greater than 10 g-mil/100 in²-day @ 100° F. and 90% relative humidity.

Gaps or openings are provided in the first film layer of the laminate film, thereby creating moisture transport windows (MTWs) that are covered by the second film layer but not by the first film layer. By controlling the number and sizes of these MTWs, the degree of moisture transport out of the package can be controlled, such that it is optimal for the intended contents. The laminate film can also include microperforations that penetrate through both of the film layers, thereby providing a limited O₂ and CO₂ gas exchange that creates a modified gaseous atmosphere within the package. These embodiments are referred to herein as Moisture Controlled Environment-Modified Atmosphere (MCE-MAP) packages.

Also disclosed herein is a method of manufacture of the disclosed MCE package. In some embodiments, the first and second film layers are adhesively laminated to each other. In some of these embodiments, the adhesive is sprayed onto one of the two layers through a mask that prevents the adhesive from being applied to designated window areas. In other of these embodiments, an adhesive-applying roller is used to apply the adhesive to one of the layers. The adhesive-applying roller includes insets that prevent the adhesive from being applied to the designated window areas. Once the adhesive has been applied, the two film layers are pressed together (laminated), for example by a pair of pressing or nip rollers.

In still other embodiments, a pressure and/or heat sensitive adhesive is applied uniformly to one of the film layers, after which the layers are pressed together by a pair of rollers that include corresponding inset and/or unheated regions that create window areas where the adhesive is not activated. In similar embodiments, the film layers are heat-sealed directly to each other by a pair of rollers that include unheated regions. As a result, the film layers are not bonded to each other in the regions that pass between the inset and/or unheated regions, thereby creating the required window areas. Under such circumstances, the adhesive used must not interfere with the moisture transfer rate of the second film layer.

After the two film layers have been laminated together, a device such as a laser or a die-cutting plate or roller is used to cut out and remove panels of the first film layer from within the window areas, while leaving the second film layer intact throughout the laminate film. In the case of a laser, the laser process conditions are adjusted such that it penetrates through the first film layer, but does not fully penetrate the second film layer. In the case of a die-cutting plate or roller, the die-cutting edges or blades extend above the surface of the plate or roller far enough to penetrate through the first film layer, but not far enough to penetrate completely through the second film layer. In embodiments, the window areas are slightly larger than the MTWs, thereby ensuring that no part of the cut panels is adhered to the second film layer.

The MCE package of the present invention is then created by cutting out a section of the laminate film in an appropriate size and shape, and bonding selected regions or “seams” of the laminate film to each other, and/or to an underlying rigid or semi-rigid container. In embodiments, the first film layer is made from a material such as PET that can be readily heat sealed, and the attachment of the “seams” of the laminate film is by heat sealing of the first film layer of the laminate film. In these embodiments, it is not necessary that the second film layer be readily heat sealable.

A first general aspect of the present invention is a laminate film suitable for incorporation in a moisture controlled fresh produce container. The laminate film includes a first film layer having a water vapor transport rate that is no greater than 3 g-mil/100 in2-day @ 100° F. and 90% relative humidity, a second film layer laminated to the first film layer, the second film layer having a water vapor transport rate that is greater than 10 g-mil/100 in2-day @ 100° F. and 90% relative humidity, and at least one moisture transport window (MTW), said MTW being a region of the laminate film that includes the second film layer, but does not include the first film layer.

In embodiments, the first film layer is a layer of heat-sealable polyethylene terephthalate (PET) film.

In any of the above embodiments, the second film layer can be a layer of nylon film. or the second film layer can be a cellulose or polylactic acid layer of film.

Any of the above embodiments can further include a plurality of microperforations suitable for establishing a modified gaseous atmosphere within the fresh produce container.

A second general aspect of the present invention is a fresh produce container that includes an interior surrounded by container walls, at least one of the container walls being at least partially formed by a laminate film according to any embodiment of the first general aspect.

In some embodiments, all of the container walls comprise the laminate film, while in other embodiments the laminate film is a lidding film applied to an underlying rigid or semi-rigid tray.

In any of the above embodiments, attachment of the laminate film so as to form the container can be by heat-sealing of the first film layer. In some of these embodiments the heat-sealing includes heat-sealing together of seam regions of the first film layer. And in any of these embodiments where the laminate film is a lidding film applied to an underlying rigid or semi-rigid tray, the heat-sealing can include heat-sealing of attachment regions of the first film layer to an upper rim of the underlying rigid or semi-rigid tray.

A third general aspect of the present invention is a method of making the laminate film of any embodiment of the first general aspect. The method includes providing a first film having a water vapor transport rate that is no greater than 3 g-mil/100 in²-day @ 100° F. and 90% relative humidity, providing a second film having a water vapor transport rate that is greater than 10 g-mil/100 in²-day @ 100° F. and 90% relative humidity, laminating the first film to the second film so as to create a laminated film comprising a first film layer of the first film and a second film layer of the second film, the first and second film layers being mutually attached to each other except within at least one window area of the laminated film, applying a cutting device to the laminated film, the cutting device being directed at the first film layer and configured to cut through the first film layer but not to cut completely through the second film layer, thereby forming a cut through the first film layer that defines and surrounds a removable panel of the first film layer that is entirely within the window area of the laminated film, and removing the removable panel from the laminated film, thereby forming a moisture transport window (MTW) within the window area that is covered by the second film layer, but within which the first film layer is absent.

In some of these embodiments, the attachment of the first film layer to the second film layer is by an adhesive. In some of these embodiments, the method includes applying the adhesive to an adhesive-applying roller having at least one inset, and applying the adhesive-applying roller to an adhesive-receiving film that is one of the first film and the second film before lamination together thereof, the adhesive not being applied to the adhesive-receiving film in gap areas that pass beneath the at least one inset, the at least one window area being formed in the gap areas during the subsequent adhesive lamination of the first film layer to the second film layer.

In other of these embodiments, the method includes positioning a mask above an adhesive-receiving film layer that is one of the first film layer and the second film layer before lamination together thereof, said mask including at least one blocked region through which access is to the underlying adhesive-receiving film layer is blocked, and spraying the adhesive through the mask and onto the adhesive-receiving film layer, the at least one window area being formed during the subsequent adhesive lamination of the first film layer to the second film layer in an area to which the adhesive was not applied to the adhesive-receiving layer because of the blocking region of the mask.

In still other of these embodiments, the adhesive is pressure and/or temperature activated, and does not interfere with a moisture transfer rate of the second film layer, and the method includes applying the adhesive uniformly to an adhesive-applied film layer that is one of the first film layer and the second film layer before lamination together thereof, aligning the first and second film layers with each other, and applying at least one of heat and pressure to the aligned first and second film layers by passing the aligned first and second film layers between a pair of laminating rollers that are configured to apply at least one of heat and pressure to the aligned first and second film layers, said laminating rollers having aligned deactivated regions that are configured not to apply the at least one of heat and pressure to the aligned first and second film layers, the at least one window area being formed during the lamination of the first film layer to the second film layer due to a failure to activate the adhesive in regions of the aligned first and second film layers to which the deactivated regions of the laminating rollers were applied.

In any of the above embodiments, the cutting device can be a laser, or a die-cutting plate or roller.

In any of the above embodiments, the removable panel can be removed from the laminated film at least partly by gravitational force.

And in any of the above embodiments, the removable panel can be removed from the laminated film at least partly by application of suction thereto.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view of a modified atmosphere package (MAP) of the prior art containing produce that is less susceptible to high moisture accumulation;

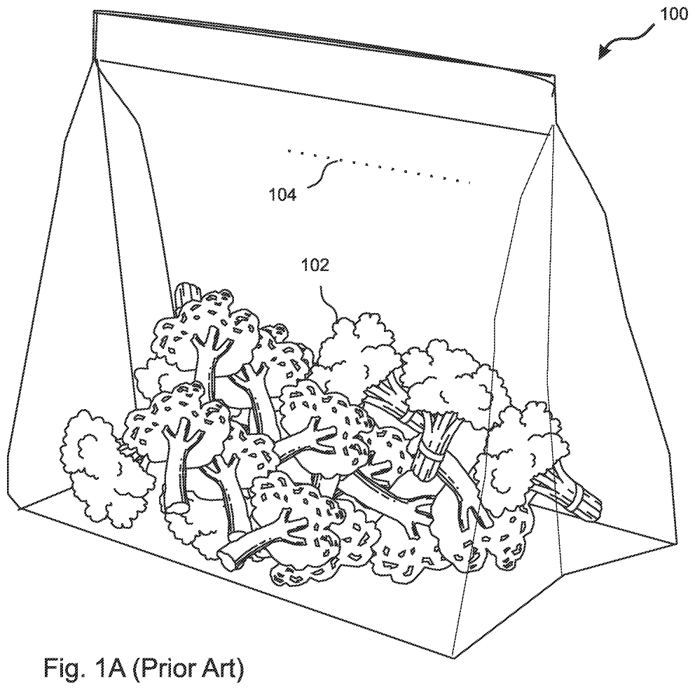

FIG. 1B is a perspective view of the package of FIG. 1A containing produce that is very susceptible to high-moisture, in which moisture has pooled;

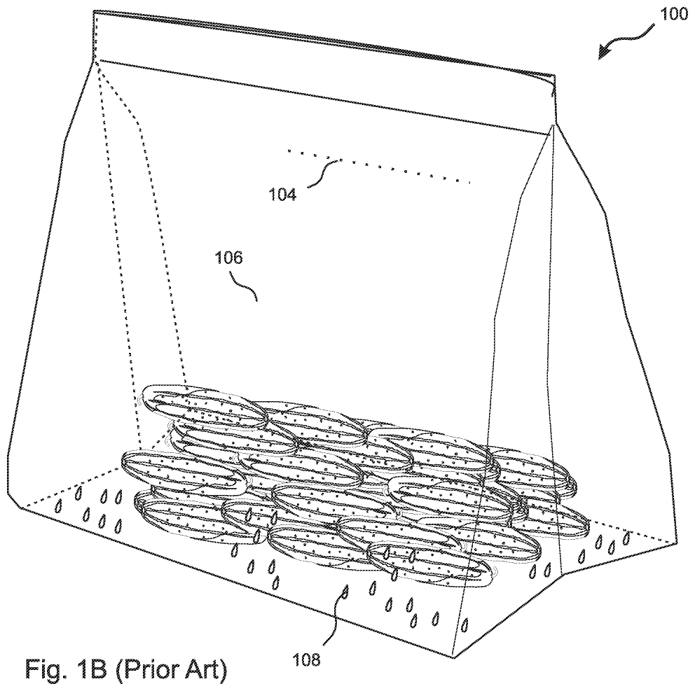

FIG. 2 is a perspective view of a package in an embodiment of the present invention that is a flexible pouch formed entirely of the disclosed laminated film, the package having two moisture transport windows (MTWs) on both the front and the back panels of the bag;

FIG. 3 is a perspective view of a package in an embodiment of the present invention in which the disclosed laminated film is applied as a lidding film to an underlying rigid or semi-rigid tray;

FIG. 4A is a perspective view showing panels of the first and second film layers of the disclosed laminated film shown separated from each other in an embodiment of the present invention;

FIG. 4B is a perspective view showing the panels of FIG. 4A laminated to each other;

FIG. 5 is a perspective view that illustrates a method of manufacture of the present invention in which a mask is used to create lamination gaps in the laminated film;

FIG. 6 is a perspective view that illustrates a method of manufacture of the present invention in which an adhesive-applying roller with insets is used to create lamination gaps in the laminated film;

FIG. 7 is a perspective view that illustrates a method of manufacture of the present invention in which lamination gaps are formed in the laminated film by applying a pressure activated adhesive and laminating the films using rollers having insets;

FIG. 8 illustrates the use of a laser to create MTWs by cutting out panels from the low water vapor transport (MVTR) layer of the film but not through the high MVTR layer in an embodiment of the present invention;

FIG. 9 illustrates the use of a die-cutting roller to create MTWs by cutting out panels from the low water transport (MVTR) layer of the film but not through the high MVTR layer in an embodiment of the present invention;

FIG. 10A is a top view of a section of laminated film in an embodiment of the present invention shown after cutting panels from the low MVTR layer of the laminated film but before removal of the panels according to an embodiment of the present invention;

FIG. 10B is a perspective view of the section of FIG. 10A showing the cut-out panel partially peeled away from the section;

FIG. 11A is a top view drawn to scale of a section of laminated film according to an embodiment of the present invention that has been cut to shape in preparation for forming a fresh produce pouch; and

FIG. 11B is a perspective view of the package formed by the cut-out laminated film of FIG. 10A.

### DETAILED DESCRIPTION

The present invention is a is fresh produce package that prevents high water vapor generating produce from being prematurely desiccated, while at the same time preventing pooling of excess moisture within the package.

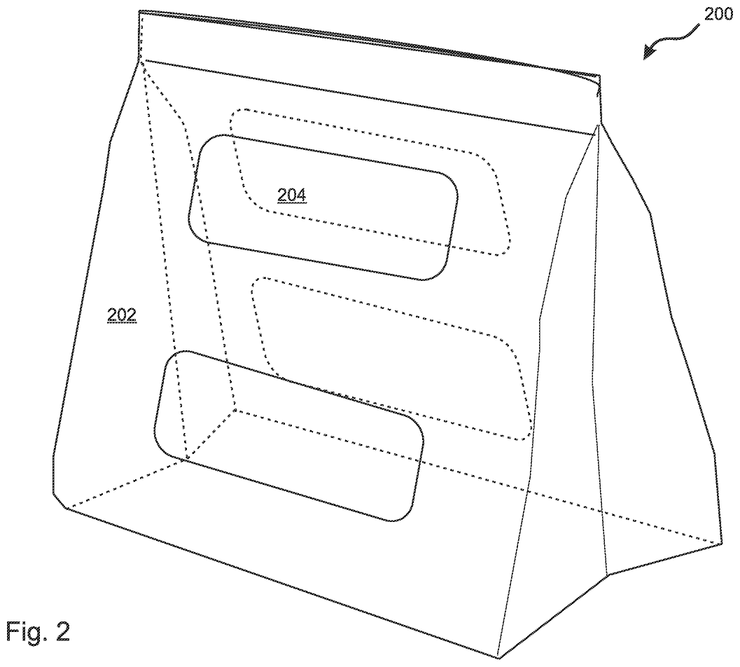

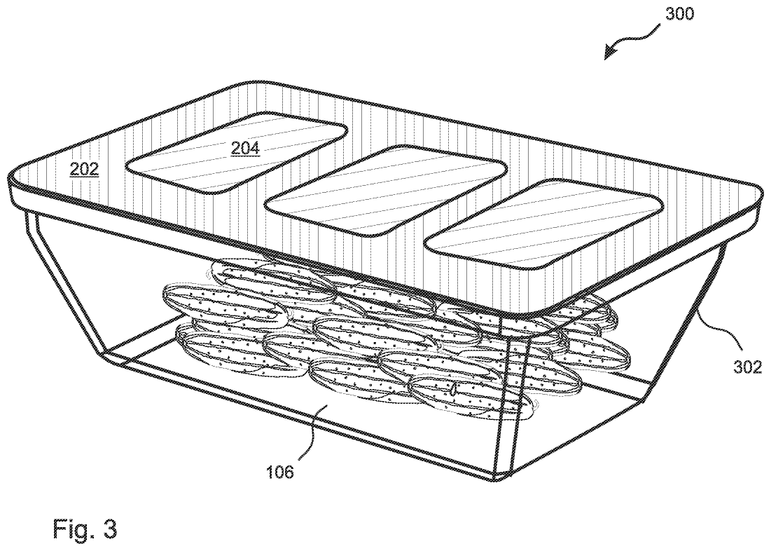

With reference to FIGS. 2 and 3, the disclosed package 200, 300 includes a laminate polymer film 202 in which moisture transport “windows” 204 (MTWs) are provided that permit a limited exchange of moisture with the environment, while limiting the O2 and CO2 gas exchange with the environment. This allows high water vapor generating high water vapor generating produce 106, such as cucumbers and peppers, to establish a moisture-controlled environment (MCE) within the package 200, 300 that avoids desiccation of the produce 106, while at the same time allowing a sufficient escape of moisture to avoid pooling of excess moisture 108 within the package 200, 300. In some embodiments, as illustrated in FIG. 2, the disclosed “MCE” packaging 200 is formed entirely by the laminate film 202, thereby providing a flexible bag or pouch 200. In other embodiments, as illustrated in FIG. 3, the laminate film 202 is applied as a lidding film to a rigid or semi-rigid container or tray 302.

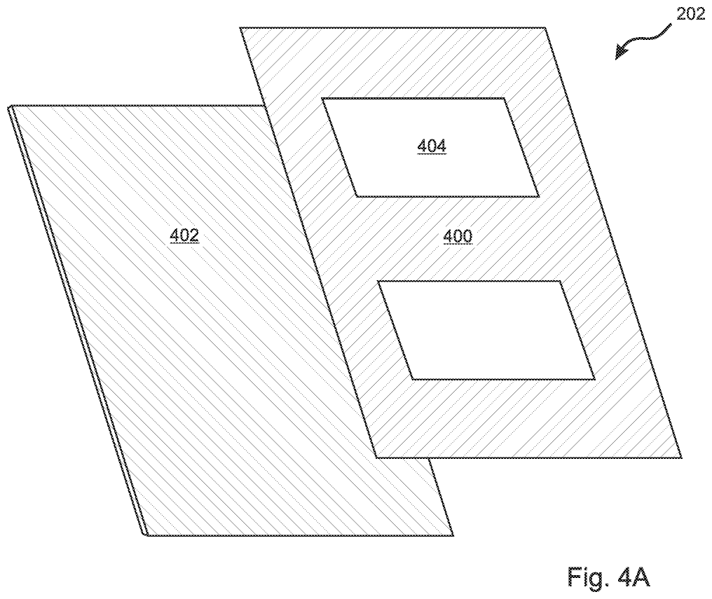

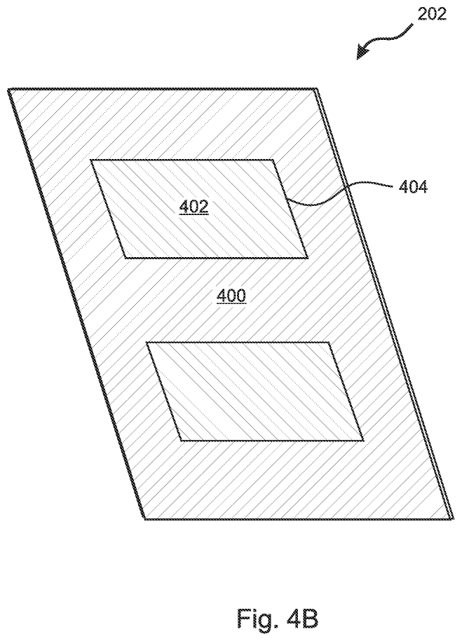

With reference to FIGS. 4A and 4B, the laminate polymer film 202 of the present invention includes a first film layer 400, such as a polyethylene terephthalate (PET) film layer, that serves as a gas and moisture barrier (very low moisture vapor transport rate, “MVTR”). The first film layer 400 is laminated to a second film layer 402, such as a nylon, PLA or cellulose layer, that also provides a very low O2 and CO2 transmission rate, but has a much higher MVTR. The high MVTR of the second film layer 402 arises from a molecular attraction between the polymer and water molecules, which draws excess moisture into the polymer, and upon saturation thereof allows some of the moisture to escape into the ambient environment. Only a limited amount of O₂ and CO₂ pass through the second film layer, because they do not experience a similar molecular attraction to the polymer as does the moisture vapor.

In embodiments, the first film layer has an MVTR (also referred to in the art as a “water” vapor transport rate, or “MVTR”) that is no greater than 3 g-mil/100 in²-day @ 100° F. and 90% relative humidity, while the second film layer has an MVTR that is greater than 10 g-mil/100 in²-day @ 100° F. and 90% relative humidity.

Gaps or openings 404 are provided in the first film layer 400 of the laminate film, thereby creating moisture transport windows (MTWs) 404 that are covered by the second film layer 402 but not by the first film layer 400. By controlling the number and sizes of these MTWs 404, the degree of moisture transport out of the package 200, 206 can be controlled, such that it is optimal for the intended contents 106. The laminate film 202 can also include microperforations 104 that penetrate through both of the film layers 400, 402, thereby providing a limited gas exchange that creates a modified gaseous atmosphere within the package. These embodiments are referred to herein as MCE-MAP packages.

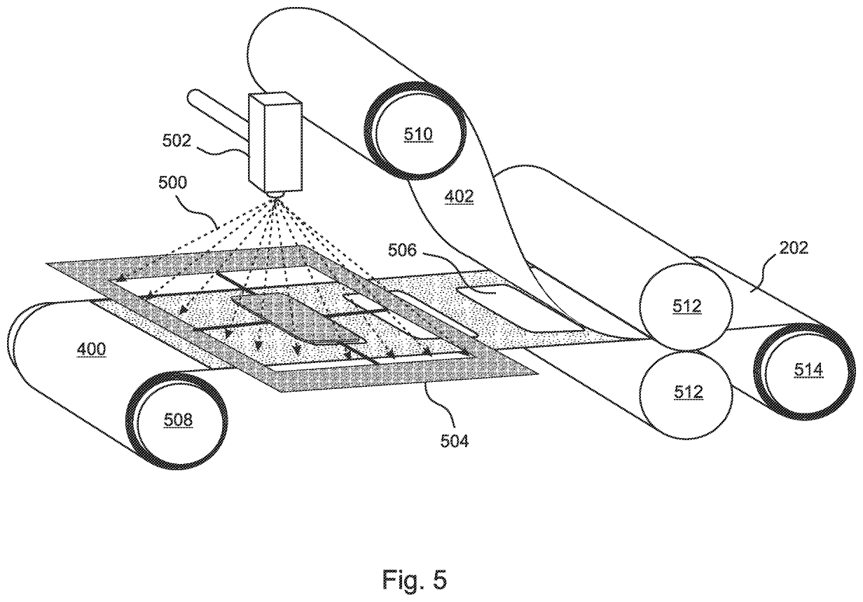

Also disclosed herein is a method of manufacture of the disclosed MCE package. In some embodiments the first 400 and second 402 film layers are adhesively laminated to each other. With reference to FIG. 5, in some of these embodiments, the laminating adhesive 500 is sprayed by an adhesive spraying device 502 onto one of the two film layers through a mask 504 that prevents the adhesive from being applied to the designated window areas 506. In the illustrated embodiment, a first PET film layer 400 is fed from a first feed roller 508 under the mask 504 through which adhesive 500 is periodically sprayed, thereby applying the adhesive 500 to the first film layer 400 in a pattern that includes gaps 506 that define the window areas 506. In embodiments, the advance of the first film layer 400 is briefly stopped each time a spray of the adhesive is applied.

A second, high water transport layer 402, such as a nylon, PLA or cellulose film layer 402, is fed from a second feed roller 510 and bonded to the first film layer 400 by laminating rollers 512 that apply pressure and/or heat to bond the second layer 402 to the first layer 400. The resulting laminate film 202 is taken up by a receiving roller 514.

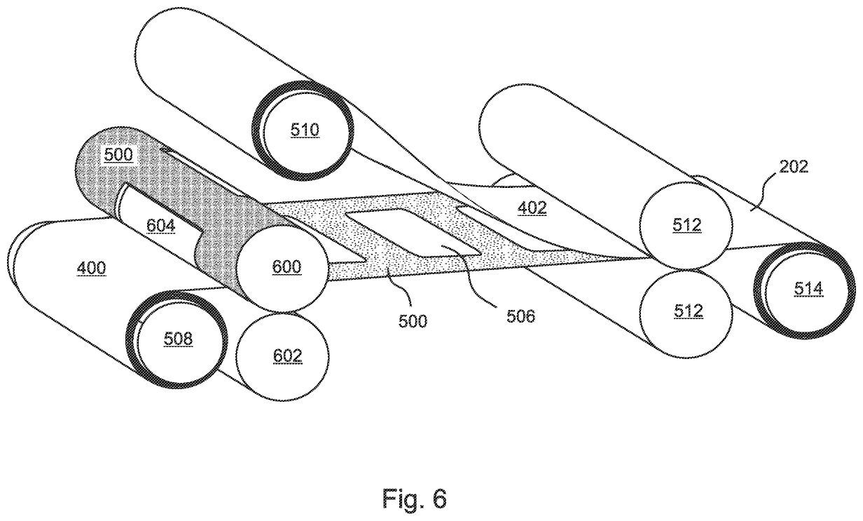

With reference to FIG. 6, in other embodiments one of the film layers passes through a pair of adhesive-applying rollers 600, 602, one of which 600 is coated by the adhesive 500, while the other roller 602 applies counter-pressure. The adhesive-coated roller 600 includes insets 604 that prevent the adhesive from being applied to the designated window areas of the film layer, which in the example of FIG. 6 is the PET first film layer 400. Once the adhesive 500 has been applied, the two film layers 400, 400 are pressed together to form the laminate film 202, as in FIG. 5.

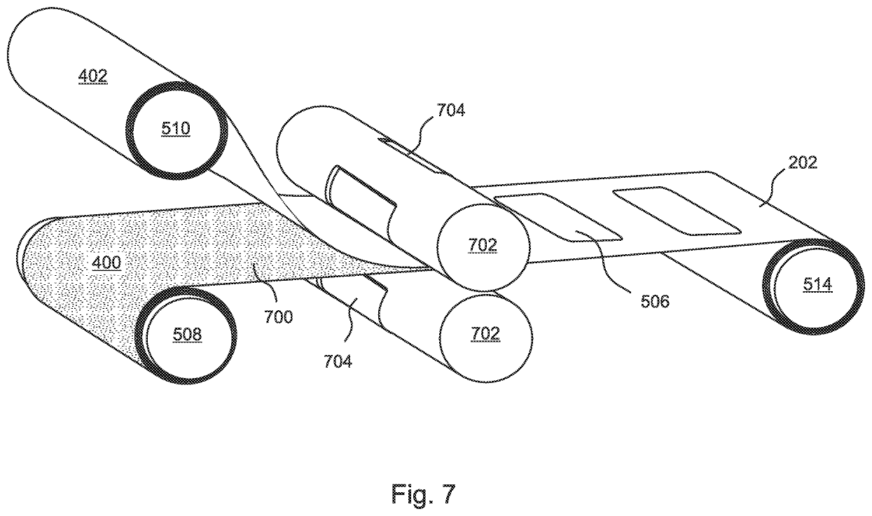

With reference to FIG. 7, in still other embodiments, a pressure and/or heat sensitive adhesive 700 is applied uniformly to one of the film layers, after which the layers 400, 402 are pressed together by a pair of rollers 702 that include corresponding inset and/or unheated regions 704. In similar embodiments, the film layers 400, 402 are heat-sealed directly to each other by a pair of rollers 702 that include unheated regions. As a result, the film layers 400, 402 are not bonded to each other in the regions 506 that pass between the inset and/or unheated regions 704, thereby creating the required window areas 506. It should be noted that these embodiments require that the adhesive used must not interfere with the moisture transfer rate of the second film layer.

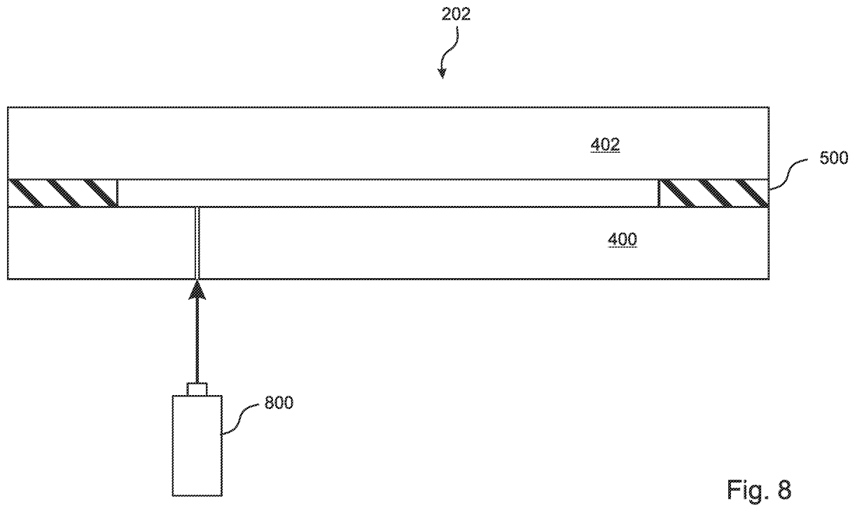

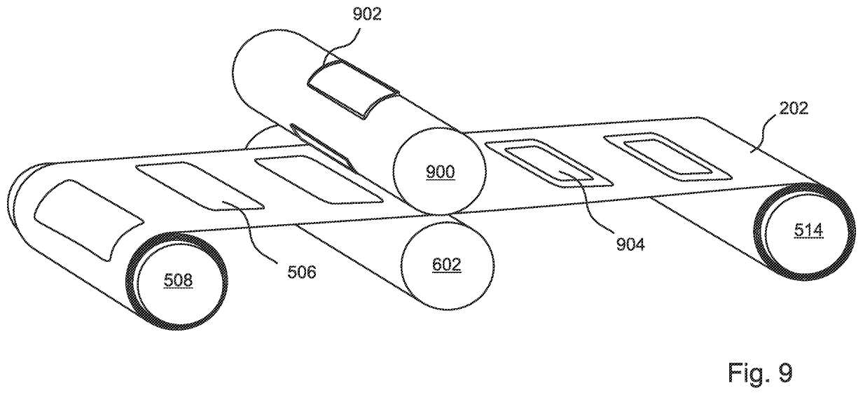

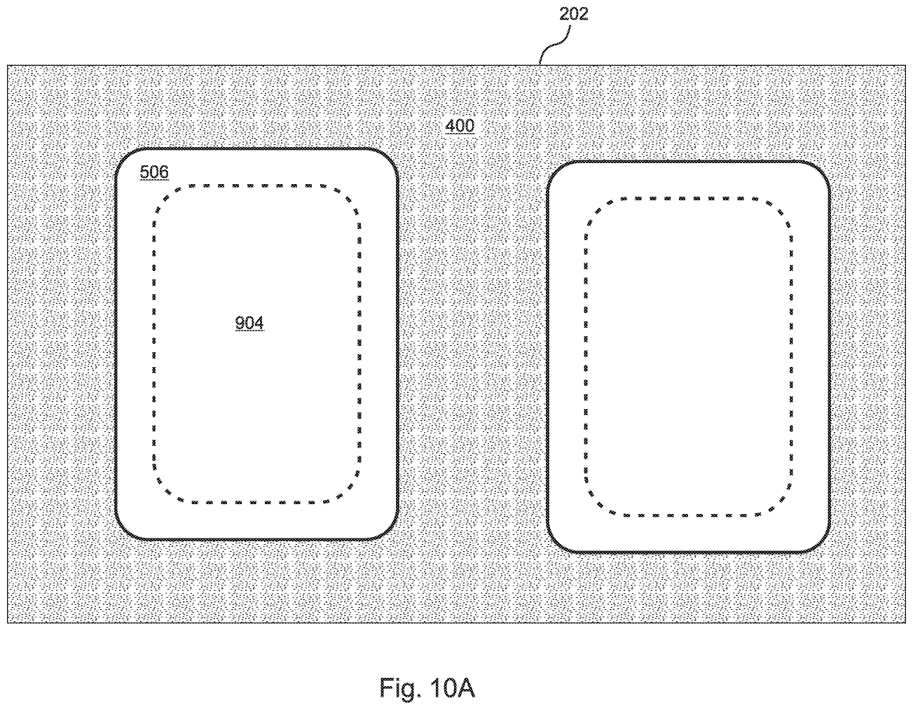

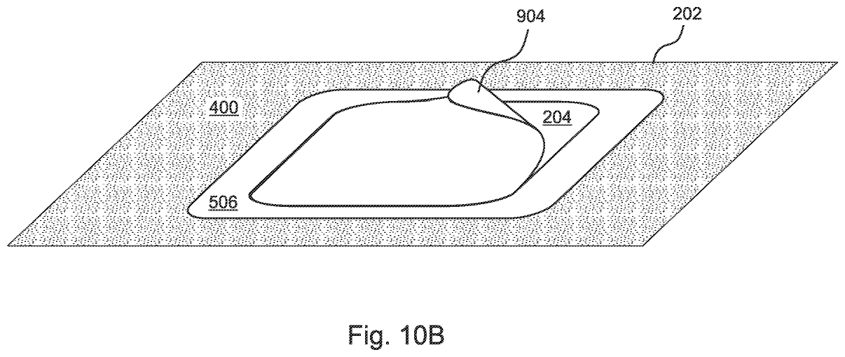

With reference to FIGS. 8-10B, after the two film layers 400, 402 have been laminated together, a device such as a laser 800 or a die-cutting plate or roller 900 is used to cut out and remove panels 904 of the first film layer 400 from within the window areas 506, while leaving the second film layer 402 intact throughout the laminate film 202. With reference to FIG. 8, in the case of a laser 800, the laser processing conditions are adjusted such that it penetrates through the first film layer 400, but does not fully penetrate the second film layer 402. With reference to FIG. 9, in the case of a die-cutting plate or roller 900, the die-cutting edges or blades 902 extend above the surface of the plate or roller 900 far enough to penetrate through the first film layer 400, but not far enough to penetrate completely through the second film layer 402. With reference to FIG. 10A, in embodiments the window areas 506 are slightly larger than the cut panels 904, thereby ensuring that no part of the cut panels 904 is adhered to the second film layer 402. With reference to FIG. 10B, this lack of adhesion allows the cut panels 904 to simply fall away from the laminate film 202, or to be easily pulled away, e.g. by a suction device (not shown).

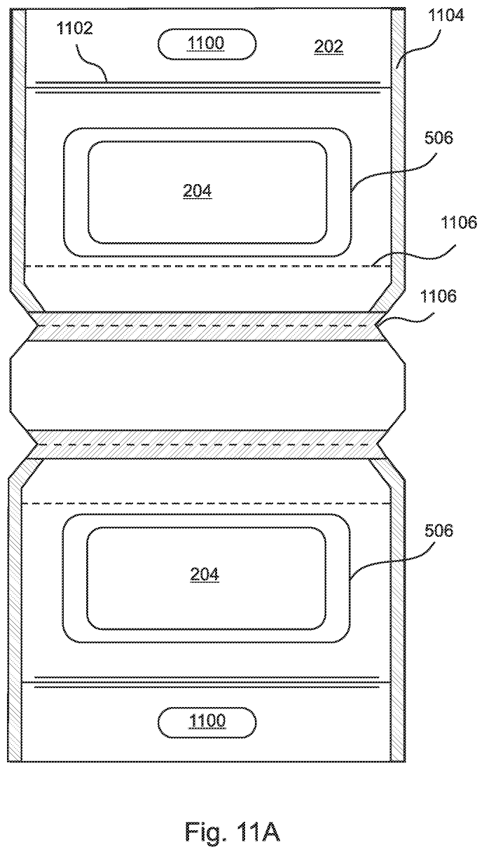

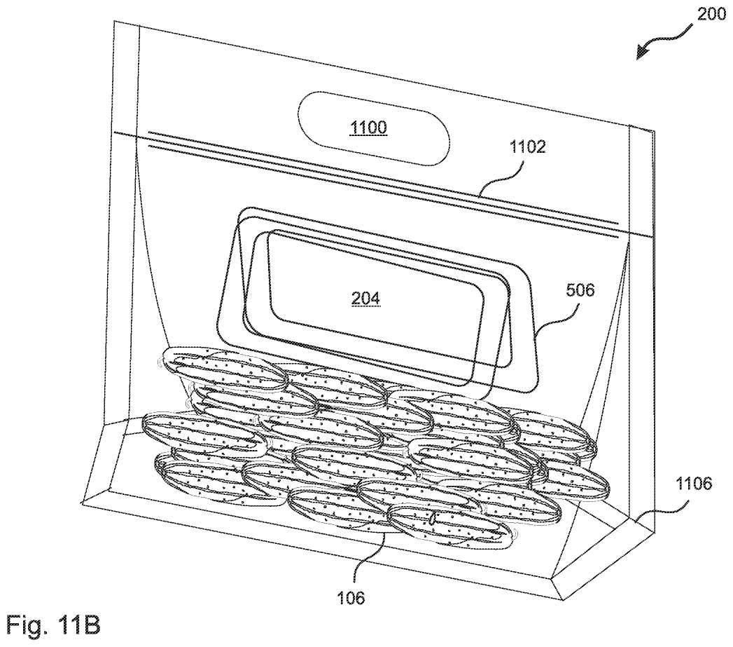

With reference to FIG. 11A, the MCE package of the present invention is then created by cutting out a section of the laminate film in an appropriate size and shape, and bonding selected regions or “seams” 1104 of the laminate film 202 to each other, and/or to an underlying rigid or semi-rigid container. In the example of FIGS. 11A and 11B, the first film layer 400 is made from a material such as heat-sealable PET that can be readily heat sealed, and the attachment of the “seams” 1104 of the laminate film is by heat sealing of the first film layers 400 to each other in the seam regions 1104. In these embodiments, it is not necessary that the second film layer 402 be readily heat sealable.

The example of FIGS. 11A and 11B further includes a cut-out opening 1100 that forms a handle, a zipper 1102, and fold lines 1106 that produce a bottom gusset. FIG. 11A illustrates that film 202 as it appears in this example before it is folded and the seams 1104 are formed, while FIG. 11B shows the resulting pouch 200 containing produce 106.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

I claim:

1. A laminate film suitable for incorporation in a moisture controlled fresh produce container, the laminate film comprising:
a first film layer having a water vapor transport rate that is no greater than 3 g-mil/100 in²-day @ 100° F. and 90% relative humidity;
a second film layer laminated to the first film layer, the second film layer having a water vapor transport rate that is greater than 10 g-mil/100 in²-day @ 100° F. and 90% relative humidity; and
at least one moisture transport window (MTW), said MTW being a region of the laminate film that includes the second film layer, but does not include the first film layer.

2. The laminate film of claim 1, wherein the first film layer is a layer of heat-sealable polyethylene terephthalate (PET) film.

3. The laminate film of claim 1, wherein the second film layer is a layer of nylon film.

4. The laminate film of claim 1, wherein the second film layer is a cellulose or polylactic acid layer of film.

5. The laminate film of claim 1, further comprising a plurality of microperforations suitable for establishing a modified gaseous atmosphere within the fresh produce container.

6. A fresh produce container comprising:
an interior surrounded by container walls, at least one of the container walls being at least partially formed by a laminate film according to claim 1.

7. The fresh produce container of claim 6, wherein all of the container walls comprise the laminate film.

8. The fresh produce container of claim 6, wherein the laminate film is a lidding film applied to an underlying rigid or semi-rigid tray.

9. The fresh produce container of claim 6, wherein attachment of the laminate film so as to form the container is by heat-sealing of the first film layer.

10. The fresh produce container of claim 9, wherein the heat-sealing includes heat-sealing together of seam regions of the first film layer.

11. The fresh produce container of claim 9, wherein:
the laminate film is a lidding film applied to an underlying rigid or semi-rigid tray; and
the heat-sealing includes heat-sealing of attachment regions of the first film layer to an upper rim of the underlying rigid or semi-rigid tray.

12. A method of making the laminate film of claim 1, the method comprising:
providing a first film having a water vapor transport rate that is no greater than 3 g-mil/100 in²-day @ 100° F. and 90% relative humidity;
providing a second film having a water vapor transport rate that is greater than 10 g-mil/100 in²-day @ 100° F. and 90% relative humidity;
laminating the first film to the second film so as to create a laminated film comprising a first film layer of the first film and a second film layer of the second film, the first and second film layers being mutually attached to each other except within at least one window area of the laminated film;
applying a cutting device to the laminated film, the cutting device being directed at the first film layer and configured to cut through the first film layer but not to cut completely through the second film layer, thereby forming a cut through the first film layer that defines and surrounds a removable panel of the first film layer that is entirely within the window area of the laminated film; and
removing the removable panel from the laminated film, thereby forming a moisture transport window (MTW) within the window area that is covered by the second film layer, but within which the first film layer is absent.

13. The method of claim 12, wherein:
the attachment of the first film layer to the second film layer is by an adhesive.

14. The method of claim 13, wherein the method includes:
applying the adhesive to an adhesive-applying roller having at least one inset; and
applying the adhesive-applying roller to an adhesive-receiving film that is one of the first film and the second film before lamination together thereof, the adhesive not being applied to the adhesive-receiving film in gap areas that pass beneath the at least one inset;
the at least one window area being formed in the gap areas during the subsequent adhesive lamination of the first film layer to the second film layer.

15. The method of claim 13, wherein the method includes:
positioning a mask above an adhesive-receiving film layer that is one of the first film layer and the second film layer before lamination together thereof, said mask including at least one blocked region through which access is to the underlying adhesive-receiving film layer is blocked; and
spraying the adhesive through the mask and onto the adhesive-receiving film layer;
the at least one window area being formed during the subsequent adhesive lamination of the first film layer to the second film layer in an area to which the adhesive was not applied to the adhesive-receiving layer because of the blocking region of the mask.

16. The method of claim 13, wherein the adhesive is pressure and/or temperature activated, and does not interfere with a moisture transfer rate of the second film layer, and wherein the method includes:
applying the adhesive uniformly to an adhesive-applied film layer that is one of the first film layer and the second film layer before lamination together thereof;
aligning the first and second film layers with each other; and
applying at least one of heat and pressure to the aligned first and second film layers by passing the aligned first and second film layers between a pair of laminating rollers that are configured to apply at least one of heat and pressure to the aligned first and second film layers, said laminating rollers having aligned deactivated regions that are configured not to apply the at least one of heat and pressure to the aligned first and second film layers;
the at least one window area being formed during the lamination of the first film layer to the second film layer due to a failure to activate the adhesive in regions of the aligned first and second film layers to which the deactivated regions of the laminating rollers were applied.

17. The method of claim 12, wherein the cutting device is a laser.

18. The method of claim 12, wherein the cutting device is a die-cutting plate or roller.

19. The method of claim 12, wherein the removable panel is removed from the laminated film at least partly by gravitational force.

20. The method of claim 12, wherein the removable panel is removed from the laminated film at least partly by application of suction thereto.
